(19) United States
(12) Patent Application Publication
(10) Pub. No.: US 2010/0203300 A1
(43) Pub. Date: Aug. 12, 2010

(54) Use of Spherical Metal Particles as Laser Marking Additives for Sealing, Closure or Coating Materials or Paints Comprising Polymer, and also Laser-Markable Sealing, Closure or Coating Material or Laser-Markable Paint Comprising Polymer

(75) Inventors: William David Coulter, Stellersee (DE); Rudiger Wittenberg, Bremen (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: ACTEGA DS GMBH, Bremen (DE)

(21) Appl. No.: 12/599,434

(22) PCT Filed: May 9, 2007
(86) PCT No.: PCT/EP2007/004113

§ 371 Date: Mar. 9, 2010

(51) Int. Cl. C09D 5/26; B32B 3/10

(52) U.S. Cl. 428/195.1; 524/439; 523/457; 524/440; 524/441

(57) ABSTRACT

The invention relates to the use of spherical metal particles which are free from antimony and/or from compounds containing antimony as laser marking agents in a sealing or closure material, coating material or paint comprising polymer, the particle-size distribution of the spherical metal particles as determined by means of laser granulometry, in the form of the volume-averaged cumulative-undersize particle-size distribution, having a D₉₉ of <110 μm, a D₉₀ of <75 μm and a D₅₀ of <45 μm. The invention further relates to a laser-markable sealing or closure material comprising polymer and to a laser-markable coating material or a laser-markable paint comprising polymer, comprising a laser marking agent consisting of spherical metal particles which are free from antimony and/or from compounds containing antimony, the particle-size distribution of the spherical metal particles as determined by means of laser granulometry, in the form of the volume-averaged cumulative-undersize particle-size distribution, having a D₉₉ of <110 μm, a D₉₀ of <75 μm and a D₅₀ of <45 μm.

The invention relates to the use of spherical metal particles as additive for laser marking of sealing materials, closure materials or coating materials or paints made of plastic material. The invention further relates to a laser-markable sealing material or a closure material made of plastic material and to a coating material or paint made of plastic materials each containing a laser marking additive according to the present invention.

Labelling of plastic materials using laser marking as well as welding of plastic parts by means of laser energy is known as such. Either is achieved by absorption of the laser energy in the plastic material either directly by means of interaction with a polymer or indirectly with a laser sensitive agent that is added to the plastic material. The laser sensitive agent may be an organic dye or a pigment that causes a locally visible discoloration of the plastic material by absorption of laser energy. It can also be a compound that is upon irradiation of laser light converted from a non-visible colourless form into a visible form. In case of laser welding the plastic material is heated by absorption of the laser energy in the contact area such that the material melts and both parts are welded to each other.

Labelling of industrial goods becomes increasingly important in nearly all industrial fields in the course of general rationalization measures. In particular, product data, batch numbers, expiry dates, product identifiers, barcodes, company labels etc. need to be applied. In contrast to conventional labelling techniques such as printing, embossing, stamping, or ticketing, laser marking is significantly faster, since it works without contact, more precise and applicable without any difficulty to non-planar surfaces. Since laser markings are generated under the surface of the material, these are durable, stable, and significantly safer against discoloration, alteration or even fraud. The contact with other materials, such as in containers for liquids and closures, is, therefore, also not critical—with the self-evident provision that the plastic matrix is resistant. Safety and durability of product identifiers as well as the absence of contamination are very important, e.g. in case of packages for pharmaceuticals, foods and beverages.

Laser marking technology is proven to be very suitable especially in connection with the marking of plastic materials. In order to be able to carry out an efficient marking of plastic material it is necessary to generate a sufficient interaction between the plastic material to be marked and the laser light. In this connection it is necessary that the energy applied to the plastic material is not too high, since then the plastic article or its texture may be damaged. On the other hand, the laser beam should not pass through the plastic material without significant interaction, since in this case marking of the plastic material is not possible.

In order to increase the interaction of the laser beam with a plastic material, plastic materials are used containing absorption agents also known as absorbers. These absorption agents may be, e.g., laser-markable polymers or also pearlescent pigments or metallic base pigments.

In case of pearlescent pigments and metallic base pigments, these pigments are heated due to the irradiation of the laser light. In the direct environment of the pearlescent pigments and the metallic base pigments there occurs a thermal alteration of the plastic material, for example carbonization or foaming of the plastic material that makes marking or identification of the plastic article possible.

DE 197 26 136 A1 discloses the use of laser-markable polymers in the form of micro-grinded particles having a particle size of 0.1 to 100 μm. A disadvantage of these laser-markable polymers is that they can be melted during processing of the plastic materials doped with the laser-markable polymers. In view of this, it is necessary that the melting range of the incorporated laser-markable polymers and the plastic systems being used are adjusted to each other.

DE 198 10 952 A1 discloses the use of pearlescent pigments or metallic base pigments as absorption agents in plastic materials. A disadvantage of using pearlescent pigments or metallic base pigments (i.e. metallescent pigments) is that in order to obtain a satisfying contrast of the laser marking the amount of pigment has to be concentrated so high that pearlescent or metallic, respectively, coloration of the plastic material necessarily occurs.

Thus, it is not satisfactorily possible by using pearlescent pigments or metallic base pigments, respectively, to apply a laser marking having a strong contrast without markable coloration in case of pearlescent pigments (pearlescent effect) or without markable metallic coloration in case of metallic base pigments (metallic base effect), respectively. In addition, metallic base pigments and pearlescent pigments are relatively expensive.

Furthermore, the plate-like structure of pearlescent pigments and of the metallic base pigments, respectively, has the disadvantage that during injection moulding of the plastic mass the pigments are aligned because of the laminar flow that occurs process-related resulting in flow lines and cords in the plastic article being produced.

In order to obtain the desired contrast upon laser marking of plastic materials, a mixture of metal or semi-metal powder, respectively, and of an effect pigment or several effect pigments based on phyllo silicates is used according to the teaching of EP 1 145 864 A1. Here, also an undesired visible coloration in case of clear and transparent plastic materials or a metallic coloration of the plastic materials, respectively, occurs. Furthermore, the pearlescent pigments also lead to generation of cords or flow lines, respectively, in the plastic article being produced, which is a disadvantage.

In DE 10 2004 053 376 A1 coloured laser markings and laser labellings of plastic materials are described based on welding of a polymer-containing labelling medium with a plastic surface. In this document spherical metal powder are inter alia mentioned as energy absorbers suitable for markings. However, there is no disclosure regarding the size of the metal powder.

According to the teaching of DE 10 2004 045 305 A1, the problem known in the prior art that the absorbers disadvantageously lead to coloration of the plastic materials to be marked can be overcome by incorporating a boride compound, preferably lanthan hexaboride, into the plastic material. A disadvantage is that these boride compounds, especially lanthan hexaboride, represent a significant cost factor. Therefore, these boride compounds are not suitable for a laser marking additive to be used in a large scale.

In order to allow marking of transparent plastic materials without coloration a laser marking additive is used according to the teaching of U.S. Pat. No. 6,693,657 B2 as well as WO 2005/047009 containing a mixture of antimony oxide and tin oxide. In WO 2005/084956 highly transparent plastic materials are described that are laser-markable and/or laser-weldable by means of indium tin oxide or antimony tin oxide particles on nanoscale. A disadvantage is that antimony oxide as well as every other antimony compound is toxic. Therefore, this laser marking additive represents an additional effort for the environment and humans during production and processing as well as during discharging, since firstly antimony or antimony-containing compounds, respectively, are used and finally the plastic articles including antimony and/or antimony-containing compounds have to be discharged again.

In WO 2002/055287 A1 a method for producing laser-welded composite moulded parts is described. Here, metal flakes and metal powders are mentioned as fillers. However, they are employed in relatively high concentrations of 1 to 60 weight percent based on the plastic moulded part.

EP 0 947 352 A1 relates to a method for printing the internal face of a closure means made of HDPE or polypropylene using a laser beam. The plastic material of the closure means comprises between 0.10 and 1.5 weight percent of the additive absorbing the laser beam. As a suitable additive, TiO₂ and ZnO₂ doted with antimony is described. Form and the particle size of the additive is not disclosed. In addition, metal particles as the additive absorbing the laser beam are not described.

In EP 1 475 238 A1, a method for marking an article made of polytetrafluoroethylene, such as e.g. a gasket ring, by means of laser irradiation is described. According to the method of EP 1 475 238 A1, no laser marking additive is necessary. However, various fillers, such as e.g. bronze powder, are described. However, the form and the particle size of the fillers is not disclosed.

WO 2006/067073 relates to a coating composition for the marking of substrates. The coating compositions comprise a colorant in an amount of from 0.01 to 50%, a metal salt of a carbonic acid in an amount of from 0.01 to 50%, a binder in an amount of from 1 to 80% and an organic solvent in an amount of from 1 to 99%, each based on the weight of the composition. A coating applied to a substrate can preferably be marked using laser beams. The use of metal particles having a special size and form is not disclosed in WO 2006/067073.

EP 0 993 964 relates to a coating of a resin and an activatable dye system for laser marking. In DE 101 36 479 a coloured labelling or marking of plastic materials, paints, including powder paints, is disclosed, wherein a colorant is transferred into the plastic material or paint by laser beams by means of a compound absorbing the laser radiation. DE 102 17 023 relates to a polymer powder for coating of metallic substrates containing a compound sensitive to laser radiation. The use of metal particles, especially spherical metal particles having a defined size, is, however, not disclosed in the above-mentioned patent applications.

The object of the present invention is to provide a laser marking additive that allows marking of sealing materials, closure materials or coating materials or paints made of transparent plastic materials with good contrast, high precision accuracy in combination with incorporation free of cords. Preferably, a good contrast should be obtained without necessarily colouring the plastic materials.

It is a further object of the present invention to provide such materials containing a toxicologically harmless laser marking additive being cheap and available in large amounts.

It is an even further object of the invention to provide such materials containing a laser marking additive allowing labelling with exact imaging of the irradiation of laser radiation.

A further object is to provide such materials containing a laser marking additive, wherein substantially no haze or coloration due to the laser marking additive occurs.

The object underlying the invention is solved by using spherical metal particles being free from antimony and/or antimony-containing compounds as laser marking additive in sealing materials, closure materials or coating materials or paints made of plastic material, wherein the particle-size distribution of the spherical metal particles as determined by means of laser granulometry, in the form of the volume-averaged cumulative-undersize particle-size distribution, has a D₉₉ of <110 μm, a D₉₀ of <75 μm and a D₅₀ of <45 μm.

Laser granulometry is a laser diffraction method in which the size of the particles is derived from the diffraction of laser radiation. Preferably, the laser diffraction method is carried out with the apparatus Helos of the company Sympatec, Clausthal-Zellerfeld, Germany, according to the instructions of the manufacturer.

In a preferred embodiment of the present invention, the plastic material of the sealing material or closure material is a thermoplastic polymer, an elastomer, a thermoplastic elastomer (TPE) or a thermoplastic vulcanisate (TPV).

In a further preferred embodiment, the plastic material of the sealing material or closure material is selected from polyethylene, a copolymer of ethylene with lower alkenes, polypropylene, thermoplastic elastomers, ethylene-propylene-copolymers, acid-modified ethylene-propylene-copolymers, styrene/butadiene-elastomer, carboxylated styrene/butadiene, polyisoprene, styrene/isoprene/styrene-block copolymers, styrene/butadiene/styrene-block copolymers, styrene/ethylene/butylene/styrene-block copolymers, polystyrene/polyethylene/propylene-block copolymers, polystyrene/polyethylene/propylene/polystyrene-block copolymers, polystyrene/polyethylene/propylene/styrene-block copolymers, polystyrene, ethylene/vinyl acetate-copolymers and -terpolymers, ethylene acrylate-copolymers and -terpolymers, ethylene/vinyl alcohol-copolymers, butyl elastomers, ethylene-copolymers made of ethylene and an acid containing olefin, polyvinylchloride polymers or mixtures thereof.

In another preferred embodiment of the present invention, the plastic material of the coating materials is selected from acryl polymers, styrene polymers and hydrogenated products thereof, vinyl polymers, polyolefins and hydrogenated or epoxidized products thereof, aldehyde polymers, epoxide polymers, polyamides, polyesters, polyurethanes, polymers on the basis of sulphone, natural polymers and derivatives thereof or mixtures thereof.

In a further preferred embodiment, the plastic material of the paint (binder) is selected from alkyd resin, chlorinated rubber, epoxy resin, acrylate resin, polyester, polyurethane or a combination of cellulose nitrate base and alkyd resin base.

Further preferred embodiments of the present invention are described in the dependent claims.

The object underlying the invention is further solved by providing a sealing material or closure material made of plastic material containing the above-defined spherical metal particles as a laser marking additive.

In a preferred embodiment the laser-markable sealing material is a sealing material for a crown cap, a cap, a screw cap, a glass plug, a spray head, a nozzle, a dust cover, a closure for aerosol caps, a valve closure or a closure for sport beverages. The laser-markable closure material is preferably a plastic cork, a cap, a screw cap, a dust cover, a closure for aerosol caps, a valve closure or a closure for sport beverages.

The object underlying the invention is further solved by providing a laser-markable coating material or a laser-markable paint made of plastic material, wherein the laser marking additive contains the above-defined spherical metal particles.

In a preferred embodiment, the paint is a powder paint, a physical drying paint, a radiation curable paint or a reactive paint having one or more components.

The present invention further relates to a marked article, obtainable by marking an above-defined coating material or closure material or an above-defined coating material or paint by irradiation using a laser.

Metal powders are known for long. They are used inter alia as starting material for the production of metal platelets. For example, zinc powder is used as corrosion pigment.

It has been surprisingly found that metal powder, designated in this application as spherical metal particles, are especially suitable as laser marking additive.

It is rather surprising that spherical metal particles allow a high-contrast labelling without necessarily clouding or colouring transparent plastic materials, such as sealing materials, closure materials or coating materials or paints. The reason therefore is presumably that due to the spherical form of the metal particles incident light is not directionally reflected in contrast to plate-like pearlescent pigments or plate-like metal base pigments and therefore is not experienced by a viewer as a strongly reflecting pigment. On the other hand, spherical metal particles are capable of absorbing irradiated laser light and, thus, of converting it into heat.

Spherical metal particles in the sense of the invention are not necessarily an absolutely concentric three-dimensional structure.

Spherical metal particles in the sense of the invention are defined as not having a plate-like form such as in case of effect pigments, e.g. pearlescent pigments or metallic base pigments. The term “spherical form” in the sense of the present invention also refers e.g. to a form that only has an approximately spherical form or is spattered. A spattered form is especially characterized in that e.g. dendritic appendices may be present on the surface of a non-plate-like body. In addition, the surface may be irregularly formed. Such spherical metal particles can be obtained, e.g. by spray aeration or atomizing of molten metal. They are commercially produced in large amounts and are obtainable at low costs, for example from the company Ecka Granules (D-91235 Velden, Germany).

In principle, spherical metal particles having a wide particle size can be used for laser marking. However, smaller metal particles are preferably used. It has been surprisingly found that especially the precision accuracy of the laser marking is improved when smaller metal particles are used. The precision accuracy is decreased if even only a small amount of metal particles that are too large are present.

Spherical metal particles have a particle-size distribution that usually has approximately the form of a log-like normal distribution. The size distribution is usually determined using laser granulometry.

In this method, the metal particles are measured in the form of a dispersion in an organic solvent. The scattering of irradiated laser radiation is determined in several directions in space and is analyzed by means of software according to the diffraction theory of Fraunhofer. In this respect, the particles are treated by calculation as spheres. Thus, the obtained diameters always refer to the equivalent sphere diameter averaged over all directions in space, irrespective of the actual form of the metal particles. The size distribution is determined, which is calculated in the form of a volume average (based on the equivalent sphere diameter). This volume averaged size distribution can be illustrated inter alia as cumulative-undersize curve (German: Summendurchgangskurve). The cumulative-undersize curve is in turn most often characterized in simplified form by means of certain characteristic values, e.g. the D₅₀ or D₉₀. The D₉₀ refers to the situation where 90% of all particles are below the denoted value. In other words, 10% of all particles are above the denoted value. In case of a D₅₀, 50% of all particles are below and 50% of all particles are above the denoted value.

The spherical metal particles according to the invention exhibit a particle-size distribution having a D₉₉ of <110 μm, a D₉₀ of <75 μm and a D₅₀ of <45 μm. Especially preferably, the inventive spherical metal particles have a D₅₀ in the range of 0.5 up to <45 μm.

In case of spherical metal particles that are too coarse having a D₉₉ of >110 μm and a D₉₀ of >75 μm, the desired contrast and especially the high precision accuracy of the laser marking are not satisfying. The same is true in case that e.g., the particle size distribution of the spherical metal particles has a D₉₉ of <110 μm and a D₉₀ of <75 μm but a D₅₀ of >45 μm. Such metal particles have an amount of fine fraction that is too low and do not have the advantages described in the present invention.

Preferably, the D₉₉ is <70 μm and the D₉₀ is <40 μm. This results preferably in particle-size distribution having a D₅₀ of <25 μm. When using these finer metal particles, the precision accuracy of the laser marking is further improved.

The term “precision accuracy” refers to a good resolution of the laser marking without single disturbing points that are especially large. Such disturbing points occur especially when using coarse metal particles.

The spherical metal particles are added to plastic material and are processed, e.g., by extrusion. During this, it can happen that individual particles are deformed to platelets (flakes of flitter) by the shear forces occurring in the extruder. This can be noticed in the plastic material as bright points, e.g. flitter, having a metallic glance. In case that this effect should not occur, spherical metal particles are to be used in a preferred embodiment exhibiting a particle-size distribution having a D₉₉ of <65 μm and a D₉₀ of <36 μm. In this respect, the D₅₀ of the particle-size distribution is preferably <20 μm. It is especially preferred that the inventive spherical metal particles have a D₅₀ in the range of 0.55 to <20 μm.

Spherical metal particles exhibiting a particle-size distribution having a D₉₉ of <55 μm and a D₉₀ of <30 μm are especially preferably used. These spherical metal particles preferably have a D₅₀ of the particle size distribution of <18 μm. In a particular preferred embodiment, the inventive spherical metal particles have a D₅₀ in the range of 0.6 up to <18 μm. With increasing fineness, i.e. with decreasing particle size of the spherical metal particles, the image sharpness and the precision accuracy of the labelling or image applied by means of the laser marking can even further be improved. Especially fine types result in a distinct high image sharpness, precision accuracy and contrast of the laser marking.

It is assumed that by using fine metal particles the absorption of laser radiation and subsequently the energy transfer into the environment of the metal particles occurs in an especially defined, locally narrowly limited way because of the high specific surface of the laser radiation absorption. Therefore, laser markings of correspondingly pigmented plastic materials exhibit the described advantages.

In a very especially preferred embodiment, inventive metal particles exhibiting a particle-size distribution having a D₉₉ of <40 μm and a D₉₀ of <20 μm are used. With respect to these spherical metal particles, the D₅₀ of the particle-size distribution is preferably <11 μm. Especially preferably, the inventive spherical metal particles have a D₅₀ in the range of 0.65 up to <11 μm.

In case of these very fine metal particles it has been surprisingly found that laser markings of high contrast and precision accuracy can be obtained at very high printing rates of the laser. The printing rates of the laser range from 120 to about 10.000 mm/Min., preferably from 150 to 8.000 mm/Min., especially preferably from 200 to 2.000 mm/Min. and very especially preferably from 230 to 1.000 mm/Min. In this respect, the individual printing rates that can be achieved are dependent on various parameters, in particular, however, on the laser output and the impulse frequency. In view of the throughput rates in laser marking of objects, this includes significant time benefits.

In accordance with a further preferred embodiment of the invention, the inventive metal particles have a metal oxide content of not more than 15 weight percent based on the total weight of the metal particles. It is further preferred that the metal oxide content of the metal particles is not more than 10 weight percent, and further preferably not more than 5 weight percent. A metal oxide content of about 0.3 to 6 and especially preferably from 0.4 to 1.5 weight percent has been shown as especially suitable.

Low metal oxide contents are advantageous in view of a fast energy input of the irradiated laser radiation into the metal particles. The lower limit of 0.3 weight percent of metal oxide content is caused by the oxide layers of the metals that form naturally.

On the one hand, the metal oxide content of the metal particles may refer to the metal oxide layer formed on the surface. For example, aluminum particles have a thin aluminum oxide layer on the surface.

Therefore, metal particles preferably consist of about 80 weight percent, further preferred about 85 weight percent, still further preferred about 90 weight percent, even more further preferred about 95 weight percent metal. Preferably, the metal particles consist of 98.5 to 99.6 weight percent metal.

Preferably, the metal particles contain metals or consist of metals selected from the group, consisting of aluminum, copper, silver, gold, zinc, tin, iron, titanium, vanadium, magnesium and alloys thereof. An alloy not necessarily has to consist of exclusively the above-mentioned metals. Further metals may be present in the alloy together with the above-mentioned metals or alloys thereof, for example, also in the form of impurities. Aluminum, silver, copper and iron have been shown as especially suitable metals. These metals resulted in a good laser markability even in the smallest concentrations. Is, for example, brass.

Due to the particle-size distribution of the metal particles on a micro-scale, the inventive laser marking additive has an especially high precision accuracy.

After irradiation of a laser beam into a plastic material containing the inventive laser marking agent, selective heating of the metal particle on a micro-scale, heat transfer into the surrounding plastic material and, in view of associated thermically induced polymer decomposition, carbonisation and/or foaming of the polymers in the plastic matrix surrounding the metal particle occur after irradiation of a laser beam. Depending on the type of the polymer used and/or depending on the energy input by the laser beam, there is carbonization and/or foaming occurring.

Carbonisation leads to black colouring; foaming leads to brightening that can even range up to a white colouring. In most cases, a distinct contrast to the non-marked plastic material is desired.

However, in further embodiments, the modification in the plastic material thermically induced by the polymer decomposition may be so marginal that it cannot be noticed or it can only be insignificantly noticed by the human eye, i.e. it cannot be noticed by the naked eye. The expression “not noticeable with a naked eye” used herein means in the sense of the present invention that the (non-enlarged) marking is not visible with a naked eye, but can be detected, however, by means of special reading devices, such as a loupe or a microscope or the like. For example, type sizes in the range of 0.7 mm are possible in this respect. Therefore, such substantially non-visible laser markings can be used, e.g., as security markings or in the discrete labelling of branded products, etc., e.g., in order to be able to discover counterfeit more easily. It is further possible to label products with, e.g., batch numbers, even in cases where a visible marking is undesired in view of aesthetic reasons.

Further embodiments are directed to the purposive discoloration of the plastic material by means of adding a colorant that can be purposively decomposed using the irradiated laser radiation. Thus, this colorant can be decomposed by the action of the laser radiation and the plastic material can assume its original colour in addition to the black colouring or brightening of colourless plastic materials or in case that further colorants are added to the plastic material that cannot be decomposed by laser radiation, can assume that basic colour.

Since carbonisation and/or foaming occurs only locally in the environment of the metal particles on micro-scale, a marking having a high precision accuracy can be achieved. A high imaging sharpness can be detected in that a line is not noticed as an accumulation of individual points but as a continuous straight line that consists of a plurality of small points that cannot be resolved by the human eye.

In view of this, it has been surprisingly found that, despite the fact that the interaction of the spherical metal particles with visible light is not strong enough for achieving greying (turbidity) of the plastic material, the interaction with irradiated laser radiation is, however, sufficient for generating the desired carbonisation and/or the desired foaming of the polymer matrix surrounding the metal particles and, therefore, for providing the plastic article with a high-contrast labelling or marking.

The spherical metal particles on micro-scale are especially suitable as laser marking agent and/or laser welding agent due to their high absorption of electromagnetic radiation in the UV up to the IR range as well due to their excellent heat conductivity. They are superior over conventional metal oxide particles in their efficiency in this respect.

The spherical metal particles may be added to the plastic material in the form of a powder. However, addition of the spherical metal particles in the form of a concentrate or master batch is more advantageous. It has been found that concentrates or master batches significantly facilitate incorporation of the spherical metal particles into the plastic materials.

Such a master batch comprises spherical metal particles as described above and at least one dispersion medium.

In the master batch, the content of spherical metal particles is 0.001 to 99.9 weight percent based on the total weight of the master batch. The content of spherical metal particles is preferably 0.5 to 95.0 weight percent, especially preferably 1.0 to 95 weight percent and still further preferably 5 to 80 weight percent, each based on the total weight of the master batch.

The dispersion medium may comprise at least one plastic component, waxes, resins, additives, solvents and/or plasticizers.

In case of a master batch being solid at room temperature (18-25° C.), the dispersion medium preferably comprises plastic components, waxes, resins and/or additives.

In this respect, a polymer is preferably used as plastic component that is compatible with the plastic material in which it is to be incorporated, i.e. it is miscible with it. According to a preferred alternative, the plastic component used in the inventive master batch is identical with the plastic material in which the laser marking additive is to be incorporated.

Polyolefin decomposition waxes or poly alkylene waxes, for example polypropylene waxes, are preferred as waxes. The polypropylene wax Licocene®, Clariant, Switzerland, has been shown to be especially suitable.

Preferred resins that may be used in the inventive master batch are phenol resins or ketone resins, such as e.g. Laropal A81 of BASF.

Stabilizers, tensides, defoaming agents, dispersing agents, corrosion inhibitors, for example organic phosphoric acids or phosphonic acides, and/or surface-active substances, etc. can be added to the laser marking additive as additives.

The additives may, for example, result in an improvement of the incorporation of the master batch into the plastic material. Agglomeration or sedimentation of the metal particles in the master batch is prevented by means of the additives. The additives simply may be mixed with the spherical metal particles or the spherical metal particles may be coated with the additives, respectively.

According to a further preferred embodiment, the master batch contains an amount of additives preferably in the range of from 0.001 to 20 weight percent based on the total weight of the master batch. According to a further preferred embodiment, the amount of additives is 0.01 to 10 weight percent, further preferably 0.01 to 4 weight percent each based on the total weight of the master batch.

In case of a master batch that is liquid at room temperature (18-25° C.), the dispersion medium preferably comprises solvent and/or plasticizers. White oil is especially preferably used as solvent. As plasticizers, usual phthalates, adipates, trimellitates, sebacates, tartaric acid derivatives, citric acid esters, polyesters, phosphates or fatty acid esters are used. Preferred examples are bis-2-ethylhexyl-phthalate, bis-2-ethylhexyl-adipate, tri-2-ethylhexyl-trimellitate or epoxidized soya bean oil.

The master batch can include further components, such as e.g. colour pigments and/or dyes.

As regards the concentration of the spherical metal particles in the master batch, two different preferred ranges are to be distinguished:

In one case, the amount of spherical metal particles in the master batch is preferably 80 to 99 weight percent and especially preferably 85 to 95 weight percent each based on the total weight of the master batch. In this case, solvents compatible with polymer such as white oil and/or plastic components as well as dispersion media are preferably added to the master batch.

The amount of plastic component in the master batch preferably ranges in this case from 0.5 to 20 weight percent, preferably 1 to 15 weight percent and especially preferred from 20 to 10 weight percent each based on the total weight of the master batch.

In an alternative embodiment, the master batch is in its composition already very similar to the laser-markable plastic material but the components are present in more concentrated form.

In this case, the amount of spherical metal particles in the master batch is preferably 0.001 to 5 weight percent and especially preferably 0.5 to 2 weight percent each based on the total weight of the master batch.

The master batch includes in this case predominantly plastic components. The amount of the plastic component in the master batch is in this case preferably in a range from 50 to 99 weight percent, preferably 60 to 98 weight percent and especially preferably from 70 to 95 weight percent each based on the total weight of the master batch. In this case, the master batch is either preferably mixed to the plastic material in advance of extrusion or is charged during the extrusion process. In addition, such a master batch usually contains additives and optionally waxes, colour pigments and/or dyes.

Lower concentrations, such as a master batch of 40% or even lower concentrations are possible, for example, in order to allow a uniform distribution of the metal particles in case of low concentrations thereof.

The master batch is produced, e.g., in a suitable mixer, for example, a wobbling mixer. In this case, the spherical metal powder as well as optionally further components are mixed with a plastic granulate or plastic powder or plastic starting material in any form, respectively, and are subsequently, for example extruded. The master batch can also be produced by directly charging the spherical metal particles as well as optionally further components into the plastic melt during the extrusion process.

Since the inventive laser marking agent consists essentially of spherical metal particles, mixing may be carried out also under intensive conditions. Deforming of the metal particles into platelets, as they are present in case of the use of metallic base pigments, can only be observed with particles that are more coarse. The obtained mixture can be directly further processed, for example in an extruder or an injection moulding device. After obtaining the desired plastic mould, labelling using a laser beam can be carried out.

Due to the size of the metal particles on micro-scale it is preferred in view of both handability reasons as well as health and safety reasons that the inventive laser marking agent or a master batch thereof is present in a low dust, preferably dust-free preparation.

In view of this, the master batch containing at least the laser marking additive and the plastic component is present in a further preferred embodiment in a compacted form. This compacted form comprises granulates, tablets, briquettes, strands, or pellets. The solvent content of such compacted forms is 0.05 to 15 weight percent and preferably 0.001 to 5 weight percent and also preferably 0.0 to <0.1 weight percent (in materials for contact with food), each based on the total weight of the compacted form. The size of compacted forms is in this respect in a range of from 50 μm to 80 mm, preferably 200 μm to 50 mm, further preferably from 500 μm to 25 mm. A very suitable size of the compacted forms of the inventive laser marking additive or the master batch is in the range of from 750 μm to 10 mm.

In this respect, compaction may be carried out by mixing spherical metal particles and plastic components and optionally a further binding agent and subsequently granulating, pelletizing, tabletting, extruding, compressing, etc. This is achieved by melting the plastic component at the appropriate temperature and thus combining it with the spherical metal particles by maintaining the forced form.

In a further embodiment the binding agent is dissolved in a suitable solvent and is mixed with the laser marking agent and optionally other additives. Subsequently, in one embodiment, the solvent is removed again under stirring under reduced pressure and/or elevated temperature. Thereby, three-dimensional, irregularly formed granulates are formed. In a further embodiment, the paste is pelletized or tabletized and subsequently dried.

The application forms described above enable a save handling and incorporation into the plastic material without the danger of dust explosions or health impairment.

It is especially advantageous in the present invention that any clouding or greying of the plastic material can be covered without any difficulty by adding colouring agents. According to the state-of-the-art, brown or green colouring that sometimes occurs can hardly be covered, since they represent a colouring in contrast to a minor clouding or greying.

According to a further embodiment of the invention the metal particles are provided with at least an inorganic metal oxide layer. The at least inorganic metal oxide layer can be applied separately to the metal particles. For example, a SiO₂ layer, an Al₂O₃ layer or a TiO₂ layer may be applied as a metal oxide layer. Furthermore, combinations of metal oxide layers may also be applied, for example, initially SiO₂ and subsequently TiO₂ or initially TiO₂ and subsequently SiO₂.

Preferably, a SiO₂ layer is applied as metal oxide layer. The SiO₂ layer is preferably applied by means of sol-gel-methods.

Tetraalkoxysilanes are preferably used as starting compounds for the SiO₂ layer. Examples for such compounds are: tetramethoxysilane, tetraethoxysilane, tetrapropoxysilane, tetraisopropoxysilane or tetrabutoxysilane or mixtures thereof.

The tetraalkoxysilane is initially hydrolyzed by addition of water under preferably a basic pH; subsequently a SiO₂ layer is deposited on the metal particles.

For catalyzing the SiO₂ decomposition, nitrogen-containing bases are preferably added, such as ammonia, alkyl- or dialkylamines. Suitable compounds are methylamine, ethylamine, dimethylamine, diethylamine, pyridine, piperazine, etc.

An organic surface modification may be applied to the metal particles in accordance with a further preferred embodiment. Between the metal particle and the organic surface modification, a further metal oxide layer, for example a SiO₂ layer, may be arranged.

The organic surface modification may be in a further embodiment an organic polymer matrix surrounding the metal particle. This matrix is preferably applied by purposive polymerization of monomers on the metal particle.

The object underlying the invention is further solved by a laser-markable sealing material or closure material. The inventive sealing material or closure material is a laser-markable sealing material or closure material containing a laser marking additive as defined above. The laser-markable sealing material or closure material can further contain a master batch as described above.

In a preferred embodiment the inventive sealing material is a sealing material for a crown cap, a cap, a screw cap, a glass stopper, a spray head, a nozzle, a dust cover, a closure for aerosol caps, a valve closure or a closure for sport beverages. In another preferred embodiment, the inventive closure material is a cap, a plastic cork, a screw cap, a dust cover, a closure for aerosol caps, a valve closure or a closure for sport beverages. A closure material according to the invention may be one-piece or multi-part. A sealing material of the invention is, for example, included as a liner in a closure means, such as a screw cap. The inventive closure material is suitable as a closure means without the use of a separate sealing.

Such materials are in principle known in the art and can be produced, for example, by injection moulding or stamping. Illustrative methods for producing sealing materials and closure materials by stamping are, for example, described in WO 02/057063, WO 01/47679, WO 01/32390 and EP 0 838 326. Illustrative methods for producing sealing materials and closure materials by stamping are, for example, described in WO 02/12087, U.S. Pat. No. 4,564,113, U.S. Pat. No. 4,774,134 and EP 0 155 976.

Suitable sealing materials are described, for example, in EP 0 770 559, WO 02/14171, WO 2004/087509, WO 02/094670 and WO 87/02305. Suitable closure materials are described, for example, in WO 03/066467, WO 99/05039, EP 0 257 623, WO 2006/013443, WO 2004/014724 and U.S. Pat. No. 5,356,019.

Beverages, foods etc., also cosmetics, personal hygiene agents and cleaning agents etc. may be considered as fills for containers using the inventive sealing material or closure material. Apart from usual packages for such beverages, foods, cosmetics, personal hygiene agents and cleaning agents, containers such as cans, buckets, barrels, as well as composites with or without metal, paper, hardboard, plastic materials or polymers, such as polyolefins, copolymers or polymers of several different polymers, respectively, TPE, TPV or rubber are suitable.

Illustrative examples of use of the paint or coating materials are a heat-seal paint, protective paint or print primer paint for cover films for food and plastic packages or pharmaceutical blister films, a sterilization resistant heat-seal paint, protective paint or print primer paint for lightweight containers of Al and cover films, an inner or outer protective paint for meal trays, a sterilization-resistant protective paint for pharmaceutical closures, an adhesive paint or abrasion-resistant outer paint for screw caps of aluminum, an outer protective paint and PU-adhesive paint for isolating plates or a hydrophilic paint or outer protective paint for heat exchanger lamellae, an adhesive paint or abrasion resistant outer paint for crown caps and closures, an inner protective paint and outer paint for cans, an inner paint or outer protective paint, sterilization-resistant heat-seal paint or sealing compound for standard-, EOE- and peelable can closure heads, a paint or sealing compound for aerosol cans, a highly flexible and abrasion-resistant protective paint for cans and jewels and cigar containers or an inner protective paint or outer protective paint for technical packages.

A paint in the sense of the present invention is not specifically limited. Rather, the term relates to all paints known to a person skilled in the art, such as e.g., a paint for cars, industrial paints, repair paints or powder paints. A group of suitable paints comprises but is not limited to powder paints, physical drying paints, radiation curable paints or reactive paints of one or more components, such as e.g. a two component polyurethane paint.

Suitable plastic materials for the inventive sealing material, closure material or coating material or the inventive paint are not specifically limited and are in principle known in the art. The present invention is, however, applicable to new developments without any difficulty. Furthermore, the present invention is suitable for bio-degradable polymers and materials. The claimed sealing materials, closure materials or coating materials or the claimed paint are distinguished from the art in that they contain a laser marking additive as described above.

The plastic material of the sealing material or closure material is not specifically limited and can be, for example, a thermoplastic polymer, an elastomer, a thermoplastic elastomer or a thermoplastic vulcanisate (TPV).

Thermoplastic elastomers (TPE) can be processed like thermoplasts but have rubber elastic properties. Suitable are TPE block polymers, TPE graft polymers and segmented TPE polymers having two or more monomeric building blocks. Especially suitable TPE are thermoplastic polyurethane elastomers (TPE-U or TPU), styrene oligoblock copolymers (TPE-S), such as SBS (styrene butadiene styrene block copolymer) and SEBS (styrene ethylene butylene styrene block copolymer, obtainable by hydrogenating SBS), thermoplastic polyolefin elastomers (TPE-O), thermoplastic polyester elastomers (TPE-E), thermoplastic polyamide elastomers (TPE-A) and especially thermoplastic vulcanisates (TPE-V). Details regarding TPE can be found by a person skilled in the art in G. Holden et al., Thermoplastic Elastomers, 2nd edition, Hanser Verlag, Munich 1996.

Preferably, the plastic material of the sealing material or closure material is selected from polyethylene, a copolymer of ethylene with other lower alkenes, polypropylene, thermoplastic elastomers, ethylen-propylene-copolymers, acid-modified ethylene-propylene-copolymers, styrene/butadiene-elastomer, carboxylated styrene/butadiene, polyisoprene, styrene/isoprene/styrene-block copolymers, styrene/butadiene/styrene-block copolymers, styrene/ethylene/butylene/styrene-block copolymers, polystyrene/polyethylene/propylene-block copolymers, polystyrene/polyethylene/propylene/polystyrene-block copolymers, polystyrene/polyethylene/propylene/styrene-block copolymers, polystyrene, ethylene/vinyl acetate-copolymers and -terpolymers, ethylene acrylate-copolymers and -terpolymers, ethylene/vinyl alcohol-copolymers, butyl elastomers, ethylene-copolymers made of ethylene and an acid containing olefin, polyvinylchloride polymers or mixtures thereof.

A “lower alkene” in the sense of the present invention is an olefin, preferably α-olefin, having 1 to 10, preferably 1 to 8 carbon atoms. An “acid-containing olefin” in the sense of the invention contains an acid functional group or an anhydride thereof, such as e.g. maleic acid, maleic acid anhydride, acrylic acid or metacrylic acid.

In an especially preferred embodiment, the plastic material of the sealing material or closure material is selected from PVC, a thermoplastic olefin, or a thermoplastic vulcanisate. Such plastic materials for sealing materials and closure materials are known in the art and are commercially available. A suitable PVC is, for example, obtainable under the trade designation SVELITH of the company DS-Chemie, Bremen, Germany. Suitable thermoplastic olefins are available under the trade designation SVELON®, OXYLON®, and POLYLINER® also from the company DS-Chemie, Bremen, Germany. A suitable thermoplastic vulcanisate is available under the trade designation NOVISEAL® from the company DS-Chemie.

In a further especially preferred embodiment, the plastic material of the sealing material or closure material is selected from LDPE, HDPE, PP and copolymers thereof, copolymers of ethylene (such as EVA, LLDPE, EEA), styrene-copolymers SIBS, SBS, SEBS or TPE or TPV, respectively.

Suitable coating materials are not specifically limited. The plastic material of the coating material can be selected, for example, from acryl polymers, styrene polymers and hydrogenated products thereof; vinyl polymers, polyolefins and hydrogenated or epoxidized products thereof, aldehyde polymers, epoxide polymers, polyamides, polyesters, polyurethanes, polymers on the basis of sulphone, natural polymers and derivatives thereof or mixtures thereof. Polyesters and epoxy paints are especially suitable.

Coating materials on the basis of resins are usual. This resin can be present as a solution in a solvent and is applied to an article to be coated using methods usual in the art. An example for a suitable resin is a resin on the basis of polyketone. A coating is formed by evaporating the solvent. The resin can be a heat curing or radiation curing resin. Suitable resins include, for example, acrylates, epoxy resins and vinyl ether. Radiation curing resins may include a photo initiator as known in the art. These compositions are applied to the substrate to be coated and are cured using suitable radiation, such as e.g. UV-radiation. Unsaturated polyester and epoxy resins can inter alia be used as heat curing resins that are applied to a substrate to be coated as a pre-polymer and are cured by heating to a suitable temperature.

Suitable coating methods are known in the art and comprise e.g., but are not limited to, coating under a liquid, pulpy or paste-like condition by brushing, painting, varnishing, dispersion coating or melt coating, extruding, casting, dipping, e.g. as hot melts, as well as coating under a solid, i.e. granular or powder-like condition by powder coating, flame spraying methods or coating by sintering. The plastic material of the inventive laser-markable paint (binding agent) is not specifically limited. Rather, paints that are conventional in the art can be used. For example, refined natural products, e.g. from rosin and oils or cellulose nitrate, and fully synthetic resins (synthetic resins) are used as binding agents. Suitable as synthetic resins are, for example, phenolic resins, amine resins (e.g. benzguanamin, urea, melamine resins), alkyd resins, polyvinyl acetate, epoxy resins, polyurethane resins, phenolic resins modified using rosin, chlorinated rubber, chlorinated polypropylene, cyclic rubber, ketone resins or acrylic resins. In a preferred embodiment, the binding agent of the paint is selected from an alkyd resin, chlorinated rubber, epoxy resin, acrylate resin, polyester, polyurethane or a combination of cellulose nitrate base and alkyd resin base. A part from the binding agent, the paint can further contain solvents, pigments, fillers and usual paint adjuvants as conventional in the art. Depending on the type of binding agent, the paint can include an organic solvent and/or water or can be free from organic solvent and/or water.

The inventive laser marking agent can be excellently incorporated in the above-mentioned materials. The designed moulds, such as sealing materials and closure materials etc., can then be produced by thermal forming of the resulting plastic laser marking agent mixture. Producing and coating of the inventive coating materials and the inventive paint is carried out, for example, from the above-mentioned plastic laser marking agent mixture in a way that is in principle known in the art.

The laser marking additive containing spherical metal particles as described above is incorporated into suitable plastic material. The amounts of the incorporated metal particles can be adjusted depending on the plastic materials and/or the intended use. The incorporation of the particles into the plastic materials can be carried out in a conventional mixer but also in an extruder in a conventional way.

According to a preferred embodiment, the content of the metal particles in the laser-markable and/or laser-weldable plastic material is 0.0005 to 0.8 weight percent, preferably 0.001 to 0.5 weight percent, wherein the above amounts each refer to the total weight of the plastic material.

It has been surprisingly found that the advantageous properties of the present invention can be achieved already using very low amounts of laser marking agent. Below of 0.0005 weight percent of laser marking agent, the inventive advantages cannot be detected or can only be detected in a very limited manner.

It is further preferred that the amount of metal particles in the plastic material is 0.005 to 0.5 weight percent, still further preferably 0.01 to 0.2 weight percent, each based on the total weight of the laser-markable plastic material.

Regarding the metals to be used, it has been found that at low concentrations especially metal particles consisting of aluminum, silver, copper or iron gave the best results. Thus, a further preferred embodiment consists of plastic materials, containing spherical metal particles made of these metals or alloys of these metals, preferably in concentrations of from 0.0005 to 0.015 weight percent based on the total plastic material.

The present invention allows the production of sealing materials and closure materials, coating material and paints from plastic material that can be labelled or marked with high contrast using a laser beam. Starting from an amount of 0.2 weight percent based on the total weight of the plastic material, the material may become opaque. In a content range between 0.05 weight percent and 0.2 weight percent an initial clouding may occur that may increase with increasing concentration to a greying of the material. Above 0.8 weight percent, the plastic material is opaque. Furthermore, no additional advantage in the quality of the laser marking can be noticed. Thus, the use of additional laser marking agent only would increase the production costs without justification.

The amount of spherical metal particles in the plastic material may in individual cases be adjusted depending on the layer thickness of the material to be marked, wherein preferably the amount of spherical metal particles may be increased with decreasing layer thickness.

Thus, the layer thickness of a film is usually in the range of 20 μm to about 5 mm. The thickness of injection moulded plastic materials, such as closure caps etc., may range up to about 6 cm.

The appropriate content of spherical metal particles can be determined by a person skilled in the art without any difficulty using experimental tests.

High contrast marking of plastic materials is—as shown in the working examples—even possible using a concentration of metal particle of 0.005 weight percent. The concentration value in weight percent each refer to the total weight of the materials and the metal particles.

Preferably the amount of metal particles is in case of a layer thickness of the plastic material in the range of from 20 μm to 500 μm in a range of from 0.005 to 0.2 weight percent, further preferably from 0.02 to 0.05, each based on the total weight of the plastic material and the metal particles.

In case of a layer thickness of the plastic material in the range of 500 μm to 2 mm, the amount of metal particles is preferably in a range of from 0.001 to 0.1 weight percent, further preferably from 0.005 to 0.05, each based on the total weight of the plastic material and the metal particle.

It has been surprisingly found that—as shown in the working examples—plastic material containing the metal particles in an amount in the range of from 0.005 to 0.05 weight percent is completely transparent and can be excellently marked at high contrast using a laser beam. Preferably, metal particles in a concentration range of from 0.01 to 0.04 weight percent are used.

This low amount of laser marking agent to be used exhibits several advantages. Thus, material characteristics of the plastic material are not or not substantially, respectively, influenced by the addition of the inventive laser marking agent.

When using metal particles in a range of from 0.001 to 0.05 weight percent in a transparent or clear plastic material, no or no substantial, respectively, deterioration of the transparency or the colour characteristics, respectively, of the material doped with the laser marking agent of the present invention occurs, wherein, however, surprisingly a high contrast marking or labelling using a laser beam is possible.

In addition, the present invention allows a very cost-effective provision of plastic material, since the laser marking agent is obtained from cheap materials and needs only to be added to the material to be marked in low amounts. This is a substantial economical advantage of the present invention.

It is advantageous for certain users if the inventive sealing material and closure material, coating material and the inventive paint made of plastic material substantially contains no pearlescent pigments. The disadvantages of pearlescent pigments in laser-markable plastic materials already were described above: Pearlescent pigments emphasize the undesired flow lines in plastic materials that are mostly present and lead to a colour modification, i.e. to a pearlescent effect. This effect is in certain cases desired in view of decorative reasons, however, in various cases the laser marking additive should not influence the colour characteristics of the plastic material, i.e. the laser marking agent has to be transparent. The plastic material itself should also be transparent and colourless or can also be coloured monochrome (e.g. blue, red, yellow, etc.). A decorative colouring by means of pearlescent is not desired in these cases.

Therefore, the inventive plastic materials should contain pearlescent pigments at maximum in amounts in which they still seem transparent and cause no flow lines. Accordingly, the inventive laser-markable materials made of plastic materials may include pearlescent pigments in concentrations of from 0 to 0.1 weight percent, preferably from 0.0 to 0.05 weight percent based on the total plastic material. The precise concentrations according to which the detrimental characteristics of the pearlescent pigments can no longer be observed naturally depend on further parameters, such as especially the layer thickness of the plastic material, however, can be determined by a person skilled in the art without any difficulty.

It is further preferred that such inventive laser-markable plastic materials substantially do not contain pearlescent pigments. Especially preferably such inventive laser-markable plastic materials do not contain pearlescent pigments.

The inventive laser-markable materials made of plastic material further may contain usual additives. These additives may be selected, for example, from the group consisting of fillers, additives, plasticizers, lubricants or deforming agents, impact modifiers, colour pigments, dyes, flame retardants, antistatic agents, optical brighteners, antioxidants, antimicrobial acting biostabilizers, chemical blowing agents or organic cross-linking agents as well as other additives or mixtures thereof.

Examples for suitable fillers are: CaCO₃ (e.g. Omya, Köln; Ulmer Füllstoff Vertrieb), Dolomit (e.g. Ziegler, Wunsiedel; Blancs Mineraux de Paris), CaSO₄ (US Gypsum, Chicago), silicate (Degussa, Frankfurt; Quarzwerke, Frechen), glass beads (Potter; GB; Owens Corning, Wiesbaden), talcum (Norwegian Talc; Nordbayrische Farben- and Mineralwerke, Hof), kaolin (AKW, Hirschau; Luh, Walluf), glimmer (Norwegian Talc; Dorther, Hirschau), feldspar (Omya, Paris), silicate beads (Langer, Ritterhude), silica (cf. silicates), BaSO₄ (Sachtleben, Duisburg; Scheruhn, Hof), Al₂O₃ or Al(OH)₃ (both of Martinswerk, Bergheim).

Additives may, for example, comprise dispersing additives, antioxidants, metal deactivating agents and/or light and UV stabilizers.

Suitable antioxidants (heat stabilizers) are, for example, sterically hindered phenols, hydrochinones, aryl amines, phosphites, various substituted members of these groups as well as mixtures thereof. They are commercially available, e.g. as Topanol® (ICI, London), Irgafos®, Irganox® (both of Ciba-Geigy, Basel), Hostanox® (Clariant, Frankfurt) or Naugard® (Uniroyal, GB).

Examples for usable metal deactivating agents are: carbonic acid amides, hydrazones, hydrazines, melamine derivatives, benzotriazole, phosphonic acid ester and/or thiazole derivatives. Specific examples are: Hostanox (Clariant, Frankfurt), Irganox (Ciba Geigy, Basel), Naugard (Uniroyal, GB).

Examples for usable light and UV stabilizers are: benzophenones, benzotriazoles, organic Ni-compounds, salicylic acid esters, cyan cinnamic acid esters, benzylidine malonates, benzoic acid esters, oxalanilides and/or stericali hinderd amins, which may be monomeric or polymeric. Specific examples therefore are: Chimasorb, Tinuvin (both of Ciba-Geigy, Basel), Cyasorb (American Cyanamid), Hostavin (Clariant, Frankfurt), Uvinul (BASF, Ludwigshafen).

Examples for useable plasticizers are: phthalic acid esters, phosphoric acid esters, adipinic acid esters, azelaic acid esters, glutaric acid esters, sebacic acid esters, fatty acid esters, preferably oleates, stearates, rizinolates, laurates and/or octanoates, with pentaerythritole, glykols, glyceroles etc., epoxidized fatty acid esters, citric acid esters, polyesters, benzoic acid esters, trimellitic acid esters, sulphonic acid esters, sulphone amides, anilides, polymerisates, polycondensates, polyethylen glycols, abietic acid esters and/or derivatives, ester of acetic, propionic, butyric, ethyl butyric and/or ethyl hexylic acid.

Examples: Carbowax (DOW, Belgium), Cetamoll (BASF, Ludwigshafen), Edenol (Henkel, Düsseldorf), Elvaloy (DuPont de Nemours, USA), Lankroflex (Lankro, GB), Palamoll, Palatinol (both of BASF, Ludwigshafen). Suitable plasticizers are, for example, often contained in sealing materials.

Examples of usable lubricants are: fatty alcohols, dicarbonic acid esters, fatty esters of glycerol and other lower alcohols, fatty acids, fatty acid amides, metallic salts of fatty acids, oligomeric fatty acid esters, fatty alcohol-fatty acid esters, wax acids and esters and soaps thereof, polar polyethylene waxes and secondary products thereof, non-polar polyolefin waxes, natural and synthetic paraffines, silicon oils and/or fluoro polymers. Specific examples are: Licowax, Ceridust, Licolub, Licomont (all of Clariant, Frankfurt), Irgawax (Ciba-Geigy, Basel), Loxiol (Henkel, Düsseldorf), Bärolub (Bärlocher, München).

Examples of usable impact modifiers are: elastomers (EPM or EPDM, respectively), polyacrylates, polybutadiene, textile glass fibres, aramide fibres and/or carbon fibres.

Colorants may comprise inorganic pigments and/or organic pigments and/or organic dyes. However, effect pigments are substantially not used.

Examples for usable flame retardants are: Suitable flame retardants are, for example, halogenated compounds known to a person skilled in the art, alone or together with antimony trioxide or phosphor-containing compounds, magnesium hydroxide, red phosphor as well as other usual compounds or mixtures thereof. Known flame retardants are, e.g. those phosphor compounds, such as phosphates, e.g. triaryl phosphates such as triskresyl phosphate, phosphites, e.g. triaryl phosphites or phosphonites, disclosed in DE-A 196 326 75 or in the Encyclopedia of Chemical Technology, editors R. Kirk and D. Othmer, vol. 10, 3rd edition, Wiley, New York, 1980, pages 340 to 420. Normally used as phosphonites bis-(2,4-di-tert.butyl phenyl)-phenyl phosphonite, tris-(2,4-di-tert.butyl phenyl)-phosphonite, tetrakis-(2,4-di-tert.butyl-6-methyl phenyl)-4,4′-biphenylylen-diphosphonite, tetrakis-(2,4-di-tert.butyl phenyl)-4,4′-biphenylylen diphosphonit, tetrakis-(2,4-di-methyl phenyl)-1,4-phenylylen-diphosphonite, tetrakis-(2,4-di-tert.butyl phenyl)-1,6-hexylylen-diphosphonit and/or tetrakis-(3,5-di-methyl-4-hydroxyphenyl)-4,4′-biphenylylen-diphosphonite, tetrakis-(3,5-di-tert.butyl-4-hydroxy-phenyl)-4,4′-biphenylylen-diphosphonit. Specific examples are: Fire Fighters (Great Lakes Chemicals), Fyrol (Dead Sea Bromine, Israel), Martinal (Martinswerk, Bergheim), Reofos (Ciba-Geigy, Basel), Phosflex (Akzo Chemicals, USA).

Examples for usable anti-statics are: ethoxylated fatty amines, aliphatic sulphonates, quarternary ammonium compounds and/or polar fatty acid esters. Suitable specific examples therefore are: Bärostat (Bärlocher, München), Dehydat (Henkel, Düsseldorf), Hostastat (Clariant, Frankfurt), Irgastat (Ciba-Geigy, Basel).

Examples for usable optical brighteners are: bis-benzotriazole, phenyl cumarine derivates, bis-styryl biphenyls and/or pyrene triazines. Specific examples are: Hostalux (Clariant, Frankfurt), Uvitex (Ciba-Geigy, Basel).

Antimicrobial acting biostabilizers (biocides) are known in the art. Examples therefore are: 10,10′-(oxy-bis-phenoxarsin, N-(trihalogen methylthio-)phthalimid, Cu-8-hydroxychinolin, tributyl tin oxide and/or its derivates, e.g. Cunilate (Ventron, B), Preventol (Bayer, Leverkusen), Fungitrol (Tenneco, USA).

Examples for usable chemical blowing agents are: hydrogen carbonate or citric acid+NaHCO₃, e.g. Hydrocerol 8 (Bohringer, Ingelheim).

Examples for usable organic cross-linking agents are diaralkyl peroxides, alkyl aralkyl peroxides, dialkyl peroxides, tert.-butyl peroxy benzoat, diacyl peroxides and/or peroxy ketales, e.g. Interox (Peroxidchemie, Höllriegelskreuth), Luperco, Luperox (Luperox, Günzburg).

Thus, the present invention allows changeless marking or labelling of inventive sealing materials and closure materials made of plastic materials without contact as well as changeless labelling of articles without contact that are coated or painted, respectively, with the inventive coating material or paint made of plastic material. For example, a container, including food containers, may be closed or coated with the inventive material. The marking or labelling can be carried out before or after adding the substance of content.

The laser-markable sealing material and closure material made of plastic material as well as the laser-markable coating material and the laser-markable paint made of plastic material according to the invention may be part of an article that itself needs not to be laser-markable and/or laser-weldable.

Marking using a conventional laser is carried out by incorporating a sample article into the optical path of a laser. The obtained marking is determined by the duration of the exposure (or number of pulses in case of pulsed lasers), respectively, and the irradiation power of the laser as well as the plastic system. The power of the laser that is used depends on the specific application and can be determined for a particular case by a person skilled in the art without any difficulty.

In principle, all usual lasers are suitable, for example, gas lasers and solid-state lasers. Gas lasers are, for example (typical wavelength of the emitted radiation are given in parentheses):

CO₂ laser (10.6 nm), argon gas laser (488 nm and 514.5 nm), helium neon gas laser (543 nm, 632.8 nm, 1150 nm), krypton gas laser (330 to 360 nm, 420 to 800 nm), hydrogen gas laser (2600 to 3000 nm) and nitrogen gas laser (337 nm).

Solid-state lasers are, for example (typical values of the emitted radiation are given in parentheses):

Nd:YAG laser (Nd³⁺Y₃Al₅O₁₂) (1064 nm), high performance diode laser (800 to 1000 nm), ruby laser (694 nm), F₂ excimer laser (157 nm), ArF excimer laser (193 nm), KrCl excimer laser (222), KrF excimer laser (248 nm), XeCl excimer laser (308 nm), XeF excimer laser (351 nm) as well as frequency multiplied Nd:YAG laser having wavelengths of 532 nm (doubled frequency), 355 nm (tripled frequency) or 266 (quadrupled frequency).

Preferred lasers for laser markings are Nd:YAG laser (Nd³⁺Y₃Al₅O₁₂) (1064 nm). For laser welding, preferred is the Nd:YAG laser (Nd³⁺Y₃Al₅O₁₂) (1064 nm) as well as the high performance diode laser (800 to 1000 nm) which both emit in the short-wave infrared range.

The lasers that are used are typically employed with powers of from 1 to 400, preferably 5 to 100 and especially 10 to 50 Watt.

The energy densities of the lasers that are used generally are in the range of 0.3 mJ/cm² to 50 J/cm², preferably 0.3 mJ/cm² to 10 J/cm². When using pulsed lasers, the pulse frequency generally is in the range of from 1 to 30 kHz. Corresponding lasers that can be used for the above purpose are commercially available.

A huge advantage of the inventive laser marking agent is that the wavelength of the laser needs not to be specifically adapted to the spherical metal particles. In contrast to metal oxides, metals have a broad absorption capability for which reason different lasers having various wavelengths can be used for laser marking of a plastic material doped with the inventive laser marking material.

Metal oxides, such as tin oxide doped with antimony are partly used as absorbent materials in the art. Despite the toxicological risks, these oxides effort the use of a defined wavelength of laser light in order to cause a marking which increases the efforts during handling thereof.

The use of the inventive laser-markable sealing material or closure material made of plastic material and of the inventive laser-markable coating materials and the laser-markable paint can be carried out in various fields in which sealing materials, closure materials, coating materials and paints are used and is not limited in this respect. For example, the present invention can be used in case of containers for personal hygiene and cosmetic. The inventive articles can be marked by means of laser light even at areas that are hardly accessible. Furthermore, the use in the field of foods or toys is possible. The markings in the sense of the invention are characterized especially in that they are smear-resistant and scratch-resistant, stable in subsequent sterilization processes and hygienically clean applicable in the marking process.

Technical advantages of the spherical metal particles used in the present invention are illustrated with respect to the examples below without being limited to these examples.

### EXAMPLE 1

A powder of spherical aluminum particles (company ECKART GmbH & Co. KG, Fürth, Germany) having a D₅₀ value of 1.57 μm, a D₉₀ value of 3.37 μm and a D₉₉ value of 7.55 μm (determined by means of laser granulometry using the device Helos, company Sympatec, Germany) was processed in a mixture with thermoplastic polypropylene (PP) (R 771-10; company DOW, Germany, Wesseling) to plates using the injection moulding process (area 42×60 mm, thickness 2 mm).

The manufacture of a 1 weight percent mixture was carried out as follows:

495 g polypropylene granulate and 5 g of the aluminum powder were mixed in a wobbling mixer and subsequently processed in a twin screw extruder (company Bersdorff, Germany, diameter 25 mm, 28 L/D) without addition of further additives at a processing temperature of about 230° C. to give a granulate. This granulate was subsequently processed by means of an injection moulding machine (Arburg Allrounder 221-55-250) at the respective material specific processing temperature (e.g. PP 260° C.) to give the sample plates having the above-mentioned dimensions.

A series of concentrations was prepared under addition of 1.0 weight percent, 0.5 weight percent, 0.2 weight percent, 0.1 weight percent, 0.05 weight percent, 0.02 weight percent, 0.01 weight percent, 0.005 weight percent and 0 weight percent of spherical aluminum particles in polypropylene and the respective plates that were obtained are marked using a Nd:YAG laser (wavelength: 1064 nm; power: 8 Watt, pulse frequency: 5 KHz, printing rate: 50-250 mm/s). The values in weight percent refer in this respect to the total weight of aluminum particles and PP.

PP plates without a content of spherical aluminum particles were not markable with the Nd:YAG laser.

When using the spherical aluminum particles starting from an amount of 0.005 weight percent in PP, high contrast, dark and abrasion-resistant markings were obtained having an excellent marginal sharpness and point accuracy. At the same time, the PP plates remained transparent and colour-neutral.

At an amount of spherical aluminum particles in the range of 0.05-0.5 weight percent, a grey colouring was increasingly noticed corresponding to a loss of transparency. PP having an amount of spherical aluminum particles of more than 0.5 weight percent were grey-opaque.

No disturbing coarse particles of flitter could be observed. In addition, already in low concentration ranges (0.005-0.02 weight percent) at high printing rates (150-200 mm/s, 8 W, pulse frequency: 5 KHz) of the laser, excellent point accuracy and high contrast could be obtained in this respect. No flow lines or cords could be observed in the PP plates containing the spherical aluminum particles.

### EXAMPLE 2

Spherical aluminum particles (company ECKART) having a D₅₀ value of 2.50 μm, a D₉₀ value of 5.46 μm and a D₉₉ value of 11.6 μm (determined using the Helos device of example 1) were processed with PP in the same manner as in example 1. The obtained results corresponded to those described in example 1.

### EXAMPLE 3

Spherical aluminum particles (company ECKART) having a D₅₀ value of 2.27 μm, a D₉₀ value of 3.83 μm and a D₉₉ value of 5.28 μm (determined using the Helos device of example 1) were processed with PP in the same manner as in example 1. The obtained results corresponded to those described in example 1.

### EXAMPLE 4

Spherical aluminum particles (company ECKART) having a D₅₀ value of 17.5 μm, a D₉₀ value of 34.5 μm and a D₉₉ value of 62.0 μm (determined by means of the Helos device of example 1) were processed with PP in the same manner as in example 1.

Beginning with contents of 0.005 weight percent of spherical aluminum particles in PP, high contrast, dark and abrasion-resistant markings could be obtained having a good marginal sharpness and point accuracy. At the same time, the PP plates remained transparent and colour-neutral. When using amounts in the range of from 0.1-1.0 weight percent spherical aluminum particles, a greyish colouring was increasingly noticed corresponding to a loss of transparency. PP plates having an amount of spherical aluminum particles of more than 1.0 weight percent were grey-opaque.

The formation of glaring flitters was observed here only to a low extent. No flow lines or cords in the PP plates containing the spherical aluminum particles could be observed.

### EXAMPLE 5

Spherical aluminum particles (company ECKART) having a D₅₀ value of 39.3 μam, a D₉₀ value of 69.1 μm and a D₉₉ value of 104 μm (determined by means of the Helos device of example 1) were processed with PP in the same manner as in example 1.

When using amounts in the range of 0.005-0.1 weight percent spherical aluminum particles in PP, high contrast, dark and abrasion-resistant markings could be obtained having a good marginal sharpness and point accuracy. At the same time, the PP plates remained transparent and colour-neutral. When using amounts in the range of 0.1-1.0 weight percent spherical aluminum particles, a greyish colouring was increasingly noticed corresponding to a loss of transparency. PP plates having an amount of spherical aluminum particles of more than 1.0 weight percent were grey-opaque.

Over the total concentration range, particles and the formation of glaring flitters could partly be observed. No flow lines or cords in the PP plates containing the spherical aluminum particles could be observed.

### COMPARATIVE EXAMPLE 6

Spherical aluminum particles (company ECKART) having a D₅₀ value of 140 μm and a D₉₀ value of 230 μm (D₉₉ value: not measurable) (determined by means of the Helos device of example 1) were processed with PP in the same manner as in example 1.

When using amounts starting in a range from 0.05 weight percent spherical aluminum particles in PP, high contrast, dark and abrasion-resistant markings could be obtained having a very low marginal sharpness and point accuracy and which were, thus, not sufficient. At the same time, the PP plates remained transparent and colour-neutral. When using amounts in the range of from 0.2-2.0 weight percent spherical aluminum particles, a greyish colouring was increasingly noticed corresponding to a loss of transparency. PP plates having an amount of spherical aluminum particles of more than 2.0 weight percent were grey-opaque. Significant amounts of coarse particles and a significant formation of glaring flitters could be observed over the total concentration range. No flow lines or cords in the PP plates containing the spherical aluminum particles could be observed.

### COMPARATIVE EXAMPLE 7

Fine aluminum effect pigments in the form of platelets (PC 200, company Eckart GmbH & Co. KG, Fürth, Germany) having a D₁₀ value of 1.51 μm, D₅₀ value of 4.02 μm and a D₉₀ value of 10.0 μm (determined by means of the Helos device of example 1) were processed with PP in the same manner as in example 1.

When using amounts of spherical aluminum particles of ≧0.005 weight percent, markings could be obtained. At the same time, the PP plates showed a grey clouding even at these amounts of aluminum effect pigments. When using an amount of 0.01 weight percent aluminum effect pigments, the grey clouding was comparable with the grey clouding obtained in example 1 at an amount of spherical aluminum particles of ≧0.1 weight percent. At a pigment content of 0.02 weight percent aluminum effect pigments, the plates were grey-opaque.

The markings were high contrast, dark and abrasion-resistant, however showed in comparison to example 1 a decreased point accuracy. The flow lines or cords, respectively, typical for products obtained by means of injection moulding of plastic materials using pigments in the form of plates were observed.

### COMPARATIVE EXAMPLE 8

Tin oxide particles doped with antimony (Mark-it™ pigments, company Engelhard Corporation, USA) were processed with PP in the same manner as in example 1.

The obtained PP plates showed properties comparable to the PP plates produced in example 1 and example 2, however, had slightly decreased point accuracies. In place of the grey colouring obtained in examples 1, 2 and 3, a brown colouring was observed here at a pigment content of 0.1 weight percent. The formation of flow lines or cords could not be observed. However, the Mark-it™ pigments that were used contained highly toxic antimony.

### COMPARATIVE EXAMPLE 9

Glimmer plates having a tin oxide coating doped with antimony (Lazerflair® 825, company E. Merck KGaA, Germany) were processed with PP in the same manner as in example 1.

The PP plates showed properties comparable to the PP plates obtained in example 1 and example 2. However, over all concentration ranges, good but in comparison to examples 1, 2, 3 and 8 decreased point accuracies were observed here, a first clouding occurred at concentrations of ≧0.1 weight percent and the medium was opaque at concentrations of 2.0 weight percent.

In place of a grey colouring obtained at a content of aluminum particles of ≧0.1 weight percent in examples 1 and 2, a greenish colouring occurred in an analogous manner in case of the Lazerflair® 825 pigments. In injection moulded plates, flow lines or cords, respectively, typical for plastic masses obtained by injection moulding using effect pigments in platelet form could be observed. The pigment Lazerflair® 825 also contains toxic antimony.

### EXAMPLE 10

A powder of spherical aluminum particles (company ECKART) having a D₅₀ value of 1.57 μm, a D₉₀ value of 3.37 μm and a D₉₉ value of 7.55 μm (determined by means of the Helos device of example 1) were processed in a mixture with thermoplastic polystyrene (PS) (Styron 678-E; company DOW, USA) by means of injection moulding to give plates (area 42×60 mm, thickness 2 mm) in the same manner as in example 1.

PS plates without a content of spherical aluminum particles were hardly markable. When using spherical aluminum particles, markings could be obtained at a content of 0.005 weight percent of spherical aluminum particles by means of a laser. Starting with a content of 0.02 weight of percent spherical aluminum particles, high contrast, dark and abrasion-resistant markings could be obtained having a satisfying marginal sharpness and point accuracy. At the same time, the PS plates remained transparent and colour-neutral. When using amounts in a range of 0.05-0.5 weight percent spherical aluminum particles, a greyish colouring of the PS plates was increasingly noticed corresponding to a loss of transparency. PS plates having an amount of spherical aluminum particles starting from 0.5 weight percent were grey-opaque. No flow lines or cords could be observed.

### EXAMPLE 11

A powder of spherical aluminum particles (company ECKART) having a D₅₀ value of 1.57 μm, a D₉₀ value of 3.37 μm and a D₉₉ value of 7.55 μm (determined by means of the Helos device of example 1) were processed in a mixture with thermoplastic polycarbonate (PC) (Calibre 201 TNT; company DOW, USA) by means of the injection moulding process in the same manner as in example 1 resulting in plates (area 42×60 mm, thickness 2 mm).

PC plates without a content of spherical aluminum particles were hardly markable.

Starting with amounts of 0.005 weight percent spherical aluminum particles, high contrast, dark and abrasion-resistant markings were obtained. The results in the further ranges of amounts corresponded to the results obtained in example 1.

### EXAMPLE 12

A powder of spherical aluminum particles (company ECKART) having a D₅₀ value of 1.57 μm, a D₉₀ value of 3.37 μm and a D₉₉ value of 7.55 μm (determined by means of the Helos device of example 1) were processed in a mixture with thermoplastic polyethylene therephthalat (PET) (Suka 5141; company Du Pont, USA) by means of the injection moulding process in the same manner as in example 1 resulting in plates (area 42×60 mm, thickness 2 mm).

PET plates without an amount of spherical aluminum particles were hardly markable. When using amounts of 0.005 weight percent spherical aluminum particles, the PET plates were markable. Starting with amounts of 0.005 weight percent, high contrast, dark and abrasion-resistant markings were obtained. The results in the further ranges of amounts corresponded to the results obtained in example 1 at good but decreased point accuracies.

### EXAMPLE 13

A powder of spherical aluminum particles (company ECKART) having a D₅₀ value of 1.57 μm, a D₉₀ value of 3.37 μm and a D₉₉ value of 7.55 μm (determined by means of the Helos device of example 1) were processed in a mixture with thermoplastic styrene acrylnitrile (SAN) (Tyril 867 E; company DOW, USA) using the injection moulding process in the same manner as in example 1 resulting in plates (area 42×60 mm, thickness 2 mm).

SAN plates without an amount of spherical aluminum particles were hardly markable. At an amount of 0.01 weight percent spherical aluminum particles, the SAN plates were markable. Starting with an amount of 0.02 weight percent spherical aluminum particles, high contrast, dark and abrasion-resistant markings were obtained. The results in the further ranges of amounts corresponded to the results obtained in example 1 with good but slightly decreased point accuracies.

### EXAMPLE 14

A powder of spherical aluminum particles (company ECKART) having a D₅₀ value of 1.57 μm, a D₉₀ value of 3.37 μm and a D₉₉ value of 7.55 μm (determined by means of the Helos device of example 1) were processed in a mixture with thermoplastic acryl butadiene styrene copolymer (ABS) (Magnum 8433; company DOW, USA) using the injection moulding process in the same manner as in example 1 resulting in plates (area 42×60 mm, thickness 2 mm).

ABS plates without an amount of spherical aluminum particles were hardly markable. At an amount of 0.005 weight percent of spherical aluminum particles, high contrast, dark and abrasion-resistant markings in bright ABS were obtained having an excellent marginal sharpness and point accuracy. At the same time, the plates remaining colour-neutral, since ABS is a material that itself is not transparent.

When using an amount of spherical aluminum particles in a range of 0.05-0.1 weight percent, a greyish colouring was increasingly observed. The ABS plates having an amount of 0.2 weight percent spherical aluminum particles were grey. No flow lines or cords could be observed.

### EXAMPLE 15

A powder of spherical aluminum particles (company ECKART) having a D₅₀ value of 1.57 μm, a D₉₀ value of 3.37 μm and a D₉₉ value of 7.55 μm (determined by means of the Helos device of example 1) was processed in a mixture with low density polyethylene (LDPE) (LDPE 410-E; company DOW, USA) by means of a film extruder scientific (company LabTech, Thailand) resulting in blow films having a thickness of 100 μm.

A series of concentrations was provided under addition of 2.0 weight percent, 1.0 weight percent, 0.5 weight percent, 0.2 weight percent, 0.1 weight percent, 0.05 weight percent and 0.02 weight percent. LDPE films were not markable without a content of spherical aluminum particles. In a range of 0.02-0.5 weight percent spherical aluminum particles, high contrast, dark and abrasion-resistant markings on transparent and colour-pure films could be obtained upon treatment with a laser. An excellent point accuracy and imaging sharpness was observed. When using an amount of ≧0.5 weight percent spherical aluminum particles, an increasing grey colouring of the films was observed.

### EXAMPLE 16

A powder of spherical aluminum particles (company ECKART) having a D₅₀ value of 1.57 μm, a D₉₀ value of 3.37 μm and a D₉₉ value of 7.55 μm (determined by means of the Helos device of example 1) was processed in a mixture with thermoplastic polyamide PA6 (Gerstamid R 200 S; company Resin Express, Germany) using the injection moulding process in the same manner as in example 1 resulting in plates (area 42×60 mm, thickness 2 mm). PA6 plates without a content of spherical aluminum particles were not markable.

The results in the further ranges of amounts corresponded to the results obtained in example 14.

In the table below, the examples and their results are again summarized.

TABLE 1
Summary of the results of the examples

| | | | | Concen- | Concen- | | | | Occurrence |
|---|---|---|---|---|---|---|---|---|---|
| | | | | trations | trations | | | | of |
| | | | | for high | at which | | Concentrations | | visible |
| | | | | contrast | clouding | Concentrations | with a loss of | | particles |
| | | | Markability of the | marking | occurs | at which | transparency | | (e.g. coarse |
| | | | polymer without | [weight | [weight | colouring occurs | (opaque medium) | Point | particles |
| Example | Additive | Polymer | additive | percent] | percent] | [weight percent] | [weight percent] | accuracy | or flitters) |
| 1 | Al-Powder | PP | not markable | ≧0.005 | ≧0.05 | ≧0.1 (greyish) | ≧0.5 | excellent | no |
| | (spherical) | | | | | | | | |
| 2 | Al-Powder | PP | not markable | ≧0.005 | ≧0.05 | ≧0.1 (greyish) | ≧0.5 | excellent | no |
| | (spherical) | | | | | | | | |
| 3 | Al-Powder | PP | not markable | ≧0.005 | ≧0.05 | ≧0.1 (greyish) | ≧0.5 | excellent | no |
| | (spherical) | | | | | | | | |
| 4 | Al-Powder | PP | not markable | ≧0.005 | ≧0.1 | ≧0.2 (greyish) | ≧1.0 | very good | minimal |
| | (spherical) | | | | | | | | |
| 5 | Al-Powder | PP | not markable | ≧0.005 | ≧0.1 | ≧0.2 (greyish) | ≧1.0 | good | yes |
| | (spherical) | | | | | | | | |
| 6 | Al-Powder | PP | not markable | ≧0.05 | ≧0.2 | ≧0.5 (greyish) | ≧2.0 | not | significant |
| (Comparative) | (spherical) | | | | | | | satisfying | |
| 7 | Al-Pigment | PP | not markable | ≧0.005 | ≧0.005 | ≧0.01 (greyish) | ≧0.02 | good | no |
| (Comparative) | (in the form | | | | | | | | |
| | of platelets) | | | | | | | | |
| 8 | Mark-it ™ | PP | not markable | ≧0.005 | ≧0.05 | ≧0.1 (brownish) | ≧0.5 | excellent | no |
| (Comparative) | (Tin oxide | | | | | | | | |
| | particles doped | | | | | | | | |
| | with antimony) | | | | | | | | |
| 9 | Lazerflair ® 825 | PP | not markable | ≧0.005 | ≧0.1 | ≧0.1 (greenish) | ≧2.0 | good | no |
| (Comparative) | (Glimmer | | | | | | | | |
| | platelets with | | | | | | | | |
| | tin oxide | | | | | | | | |
| | coating doped | | | | | | | | |
| | with antimony) | | | | | | | | |
| 10 | Al-Powder | PS | hardly markable | ≧0.02 | ≧0.05 | ≧0.1 (greyish) | ≧0.5 | satisfying | no |
| | (spherical) | | | | | | | | |
| 11 | Al-Powder | PC | hardly markable | ≧0.005 | ≧0.05 | ≧0.1 (greyish) | ≧0.5 | excellent | no |
| | (spherical) | | | | | | | | |
| 12 | Al-Powder | PET | hardly markable | ≧0.005 | ≧0.05 | ≧0.1 (greyish) | ≧0.5 | good | no |
| | (spherical) | | | | | | | | |
| 13 | Al-Powder | SAN | hardly markable | ≧0.02 | ≧0.05 | ≧0.1 (greyish) | ≧0.5 | good | no |
| | (spherical) | | | | | | | | |
| 14 | Al-Powder | ABS | hardly markable | ≧0.005 | ≧0.05 | ≧0.1 (greyish) | ABS is not | excellent | no |
| | (spherical) | | | | | | transparent | | |
| 15 | Al-Powder | LDPE | not markable | ≧0.02 | ≧0.05 | ≧0.05 (greyish) | ≧0.05 | very good | no |
| | (spherical) | | | | | | | | |
| 16 | Al-Powder | PA6 | not markable | ≧0.005 | ≧0.05 | ≧0.1 (greyish) | PA 6 is not | excellent | no |
| | (spherical) | | | | | | transparent | | |

As can be seen in the summarizing table 1, the use of spherical metal particles in the sense of the present invention allows the provision of laser-markable plastic materials that are transparent and at the same time can be marked with a laser at good contrast and high imaging sharpness.

A very good contrast marking is normally obtainable starting with an amount of spherical aluminum particles of 0.005 weight percent based on the total weight of the plastic mass. A grey colouring or clouding normally occurs at an amount of spherical aluminum particles starting with 0.05 weight percent.

It can be seen in comparative example 7 that when using aluminum effect pigments of comparable particle size a clouding or grey colouring occurs also when the plastic material is laser-markable. In this respect, the respective limit is at 0.005 weight percent.

When comparing comparative examples 5 and 6, it can be seen that the present invention allows the provision of laser-markable plastic materials without using highly toxic antimony-containing compounds or particles.

In comparative examples 17 and 18 as well as in example 19 below, it is shown that when using pearlescent pigments as laser marking agent, flow lines are made visible or flow lines occur, respectively.

### COMPARATIVE EXAMPLE 17

### In Accordance with EP 1 145 864 A1

In the same manner as in example 1, a silver pearlescent pigment (PX1001, company ECKART) in a concentration of 0.49 weight percent was processed in polypropylene (PP).

In this respect, high contrast, dark and abrasion-resistant markings could be obtained having a satisfying to sufficient marginal sharpness and point accuracy. However, the PP plates were at the same time pearlescent, bright and opaque. The formation of flow lines in the PP plates was observable very clearly.

### COMPARATIVE EXAMPLE 18

### In Accordance with EP 1 145 864 A1

In the same manner as in example 1, silver pearlescent pigment (PX1001, company ECKART) in a concentration of 0.49 weight percent and zinc powder having a particle size distribution of: D₁₀: 1.9 μm; D₅₀: 3.4μ; D₉₀: 6 μm (zinc powder 17640, manufacturer: company Norzinko GmbH, Goslar, Germany) with 0.0098 weight percent in polypropylene (PP).

The results corresponded exactly to those mentioned under comparative example 17.

### EXAMPLE 19

In the same manner as in example 1, zinc powder (zinc dust 17640, company

Norzinko GmbH, Goslar, Germany) was processed with polypropylene (PP). When using the zinc powder starting with an amount of 0.005% with respect to PP, high contrast, dark and abrasion-resistant markings could be obtained having a satisfying marginal sharpness and point accuracy. Starting with additions of 0.05 weight percent, very good point accuracies and marginal sharpness were obtained. At the same time, the PP plates remaining transparent and colour-neutral.

Starting with an amount of zinc powder of 0.05 weight percent, a greyish colouring was increasingly observed corresponding to a loss of transparency. PP plates having an amount of zinc powder of more than 1.0 weight percent were grey-opaque. However, only good markings could be obtained at low printing rates of the Nd:YAG laser (50 mm/s, 8 W, pulse frequency: 5 KHz) at very good point accuracies and high contrast.

No flow lines or cords could be observed in the PP plates containing the spherical aluminum particles.

### EXAMPLE 20

In the same manner as in example 1, silver pearlescent pigment (PX1001, company ECKART) in a concentration of 0.05 weight percent and zinc powder (zinc dust 17640, company Norzinko GmbH, Goslar, Germany) in a concentration of 0.25 weight percent and 0.05 weight percent was processed in polypropylene (PP). The results were comparable to those described in example 19, however, point accuracies decreased to some extent were observable here. The plates remained transparent at the concentrations noted, however, the formation of flow lines was already observable.

The results of the examples 19 and 20 show clear advantages over the comparative examples 17 and 18 when using metal particles without or with only low amounts of pearlescent pigments. No advantage can be derived from the results of both comparative examples 17 and 18 when using zinc powder. The comparison of both examples 19 and 20 shows that flow lines can already occur even at low amounts of pearlescent pigments.

In examples 21 to 24 below, the specific suitability of metal particles as laser-welding agent is shown.

### EXAMPLE 21

A powder of spherical aluminum particles having a D₅₀ value of 1.57 μm, a D₉₀ value of 3.37 μm and a D₉₉ value of 7.55 μm (determined by means of the Helos device of example 1) was processed in a mixture of 0.05 weight percent with thermoplastic polypropylene (R 771-10; company DOW, USA) by means of the injection moulding process resulting in plates (analogous to example 1, area 42×60 mm, thickness 2 mm).

A plate thus obtained was covered with a corresponding non-pigmented plate of thermoplastic polypropylene (R 771-10; company DOW, USA) and irradiated by means of a Nd:YAG laser (1064 nm; 8 W, pulse frequency 5 KHz; printing rate 50 mm/s) on an area of 10×10 mm. Thereby, melting of the plates to each other at their contact areas in the irradiated area could be achieved. The welding could only be separated again using force.

### COMPARATIVE EXAMPLE 22

In the same manner as in example 20, two non-pigmented plates of thermoplastic polypropylene (R 771-10; company DOW, USA) were processed. Thereby, no melting of the plastic plates to each other could be obtained.

### EXAMPLE 23

A powder of spherical aluminum particles having a D₅₀ value of 1.57 μm, a D₉₀ value of 3.37 μm and a D₉₉ value of 7.55 μm (determined by means of the Helos device of example 1) were processed to blow films in a mixture of 0.5 weight percent with low density polyethylene (LDPE) (LDPE 410-E; company DOW, USA) having a thickness of 100 μm by means of a film extruder of the type: Scientific, company LabTech, Thailand. A piece of film (110×70 mm) was covered with a corresponding non-pigmented LDPE film and was treated in the same as in example 20. Thereby, melting of the films together at their contact areas in the irradiated area could be achieved. The welding could only be separated again by means of force and under destruction of the films at the melting area.

### COMPARATIVE EXAMPLE 24

In the same manner as in example 22, two non-pigmented films of low density polyethylene (LDPE) (LDPE 410-E, company DOW, USA) were processed. Thereby, no melting of the plastic films to each other could be achieved.

1. A method for laser marking an article, comprising:
providing an article, the article comprising:
a plastic material, wherein the plastic material is selected from the group consisting of a sealing material, a closure material, a coating material, and a paint; and
a laser marking additive in the plastic material, wherein the laser marking material comprises spherical metal particles, wherein the spherical metal particles are free from antimony and from compounds containing antimony and wherein the spherical metal particles have a particle-size distribution, as determined by means of laser granulometry in the form of the volume-averaged cumulative-undersize particle-size distribution, with a D₉₉ of <110 μm, a D₉₀ of <75 μm and a D₅₀ of <45 μm; and
irradiating the article with a laser to mark the plastic material.

2. The method according to claim 1, wherein the plastic material is the sealing material or the closure material and wherein the plastic material is a thermoplastic polymer, an elastomer, a thermoplastic elastomer, or a thermoplastic vulcanizate.

3. The method according to claim 1, wherein the plastic material is the sealing material or the closure material and wherein the plastic material is selected from the group consisting of polyethylene, a copolymer of ethylene with lower alkenes, polypropylene, thermoplastic elastomers, ethylene-propylene-copolymers, acid-modified ethylene-propylene-copolymers, styrene/butadiene-elastomer, carboxylated styrene/butadiene, polyisoprene, styrene/isoprene/styrene-block copolymers, styrene/butadiene/styrene-block copolymers, styrene/ethylene/butylene/styrene-block copolymers, polystyrene/polyethylene/propylene-block copolymers, polystyrene/polyethylene/propylene/polystyrene-block copolymers, polystyrene/polyethylene/propylene/styrene-block copolymers, polystyrene, ethylene/vinyl acetate-copolymers and -terpolymers, ethylene acrylate-copolymers and -terpolymers, ethylene/vinyl alcohol-copolymers, butyl elastomers, ethylene-copolymers made of ethylene and an acid containing olefin, polyvinylchloride polymers and mixtures thereof.

4. The method according to claim 1, wherein the plastic material is the sealing material or the closure material and wherein the plastic material is selected from the group consisting of PVC, thermoplastic olefins and thermoplastic vulcanizates.

5. The method according to claim 1, wherein the plastic material is the sealing material or the closure material and wherein the plastic material is selected from the group consisting of LDPE, HDPE, PP and copolymers thereof, copolymers of ethylene, the styrene-copolymers SIBS, SBS, SEBS, TPE and TPV.

6. The method according to claim 1, wherein the plastic material is the coating material and wherein the plastic material is selected from the group consisting of acryl polymers, styrene polymers and hydrogenated products thereof, vinyl polymers, polyolefins and hydrogenated or epoxidized products thereof, aldehyde polymers, epoxide polymers, polyamides, polyesters, polyurethanes, polymers on the basis of sulphone, natural polymers, derivatives thereof, and mixtures thereof.

7. The method according to claim 1, wherein the plastic material is the coating material and wherein the plastic material is selected from the group consisting of polyesters and epoxy paints.

8. The method according to claim 1, wherein the plastic material is the paint and wherein the plastic material is selected from the group consisting of alkyd resin, chlorinated rubber, epoxy resin, acrylate resin, polyester, polyurethane and a combination of cellulose nitrate base and alkyd resin base.

9. The method according to claim 1, wherein the cumulative-undersize particle-size distribution of the spherical metal particles has a D₉₉ of <70 μm and a D₉₀ of <40 μm.

10. The method according to claim 1, wherein the metal particles comprises a metal selected from the group consisting of aluminum, copper, silver, gold and zinc, tin, iron, titanium, vanadium, magnesium and alloys thereof.

11. The method according to claim 1, wherein the metal particles have a metal oxide content of not more than 10 weight percent based on a total weight of the metal particles.

12. The method according to claim 1, wherein the metal particles have at least an inorganic metal oxide layer.

13. The method according to claim 12, wherein the metal oxide layer comprises SiO₂.

14. A laser markable material comprising:
a plastic material, wherein the plastic material is selected from the group consisting of a sealing material and a closure material; and
a laser marking additive in the plastic material, wherein the laser marking material comprises spherical metal particles, wherein the spherical metal particles are free from antimony and from compounds containing antimony and wherein the spherical metal particles have a particle-size distribution, as determined by means of laser granulometry in the form of the volume-averaged cumulative-undersize particle-size distribution, with a D₉₉ of <110 μm, a D₉₀ of <75 μm and a D₅₀ of <45 μm.

15. The laser markable material according to claim 14, wherein the laser markable material is a sealing material for a crown cap, a cap, a screw cap, a glass stopper, a spray head, a nozzle, a dust cover, a closure for aerosol caps, a valve closure or a closure for sports beverages.

16. A laser markable comprising:
a plastic material, wherein the plastic material is selected from the group consisting of a coating material and a paint; and
a laser marking additive in the plastic material, wherein the laser marking material comprises spherical metal particles, wherein the spherical metal particles are free from antimony and from compounds containing antimony and wherein the spherical metal particles have a particle-size distribution, as determined by means of laser granulometry in the form of the volume-averaged cumulative-undersize particle-size distribution, with a D₉₉ of <110 μm, a D₉₀ of <75 μm and a D₅₀ of <45 μm.

17. The laser markable material according to claim 16, wherein the laser markable material is the paint and wherein the laser markable material is a powder coating, a physical drying paint, a radiation curable paint or a reactive paint of one or more components.

18. The laser markable material according to claim 16, wherein laser markable material is the paint and wherein the laser markable material is selected from the group consisting of heat-seal paint, protective paint or print primer paint for cover films for food and plastic packages or pharmaceutical blister films, a sterilization resistant heat-seal paint, protective paint or print primer paint for lightweight containers of Al— and cover films, an inner or outer protective paint for meal trays, a sterilization resistant protective paint for pharmaceutical closures, an adhesive paint or abrasion resistant outer paint for screw caps of aluminum, an outer protective paint and PU adhesive paint for isolating plates or a hydrophilic paint or outer protective paint for heat exchanger lamellae, an adhesive paint or abrasion resistant outer paint for crown caps and closures, an inner protective paint and outer paint for cans, an inner paint or outer protective paint, sterilization resistant heat-seal paint or sealing compound for standard-, EOE- and peelable can closure heads, a paint or sealing compound for aerosol cans, a highly flexible and abrasion resistant protective paint for cans for jewels and cigars and an inner protective paint or outer protective paint for technical packages.

19. The laser markable material according to claim 14 wherein a content of the metal particles in the plastic material is 0.0005 to 0.8 weight percent based on a total weight of the plastic material.

20. A marked article made according to the method of claim 1.

21. The marked article according to claim 20, wherein the marking cannot be observed with a naked eye.

22. The laser markable material according to claim 14, wherein the laser markable material is the closure material and wherein the laser markable material is a cap, a plastic cork, a screw cap, a dust cover, a closure for aerosol caps, a valve closure or a closure for sports beverages.

23. The laser markable material according to claim 17, wherein a content of the metal particles in the plastic material is 0.0005 to 0.8 weight percent based on a total weight of the plastic material.

24. The laser markable material according to claim 19, wherein a content of the metal particles in the plastic material is 0.01 to 0.1 weight percent based on a total weight of the plastic material.
